(19) United States
(12) Patent Application Publication
(10) Pub. No.: US 2009/0027515 A1
(43) Pub. Date: Jan. 29, 2009

(54) IMAGE PICKUP APPARATUS

(76) Inventors: Atsushi MARUYAMA, Sagamihara (JP); Daiki Yasumoto, Yokohama (JP)

Correspondence Address: STRAUB & POKOTYLO, 788 Shrewsbury Avenue, TINTON FALLS, NJ, 07724, US

(21) Appl. No.: 12/171,757

(22) Filed: Jul. 11, 2008

(30) Foreign Application Priority Data
Jul. 26, 2007 (JP) 2007-195218

(51) Int. Cl. H04N 9/73; H04N 5/235; H04N 5/228

(52) U.S. Cl. 348/223.1; 348/229.1; 348/222.1; 348/E05.034; 348/E09.051; 348/E05.031

(57) ABSTRACT

An image pickup apparatus includes: an image pickup unit capturing a subject; an image generation unit performing image processing by different parameter values of a same parameter on an original image captured by the image pickup unit, and generating a plurality of images; and a multi-window display unit displaying the plurality of images generated by the image generation unit or the original image and the plurality of images generated by the image generation unit. The parameter is exposure correction or white balance.

### CROSS REFERENCE TO RELATED APPLICATIONS

This application is based upon and claims the benefit of priority from the prior Japanese Patent Application No. 2007-195218, filed Jul. 26, 2007, the entire contents of which are incorporated by reference.

### BACKGROUND OF THE INVENTION

1. Field of the Invention

The present invention relates to an image pickup apparatus capable of changing a shooting mode and a shooting parameter.

2. Description of the Related Art

Recently, a number of digital cameras having the function of changing a shooting mode and a shooting parameter have been put on sale. These digital cameras can generate better images in many cases by changing the shooting mode and the shooting parameter depending on the shooting situation.

For example, there is a white balance as the shooting parameter of the digital camera. In recent years, a camera is generally provided with the function of auto-white-balance for automatically adjusting white balance. The auto-white-balance is to automatically adjust image processing to take a white subject as white under any light source. However, when the color of the entire shooting range is biased toward a certain color, the color is corrected to white. Accordingly, an image is not always output in preferable color. Therefore, there are a number of cameras provided in a preset white balance mode. The preset white balance is to store a plurality of typical color temperature values as the center value data of the white balance adjustment in a digital camera in advance. Thus, the color temperature values can be selected depending on the light source illuminating a subject under fine weather, cloudy weather, an electric lamp, a fluorescent lamp, etc.

The patent document 1 (Patent Publication No. 3139028) discloses the technology of displaying a plurality of different images and recording an image selected from among the plurality of images. In this technology, the plurality of images are different in angle of view, focal distance, and exposure obtained by preparatory taking.

The patent document 1 describes an image pickup apparatus capable of displaying a plurality of images different in angle of view, focal distance, and exposure obtained by preparatory taking, and recording a desired image from among the images.

### SUMMARY OF THE INVENTION

The image pickup apparatus according to an aspect of the present invention includes: an image pickup unit for capturing a subject; an image generation unit for performing image processing by different parameter values of a same parameter on an original image captured by the image pickup unit, and generating a plurality of images; and a multi-window display unit for displaying the plurality of images generated by the image generation unit or the original image and the plurality of images generated by the image generation unit. The parameter is exposure correction.

The image pickup apparatus according to another aspect of the present invention includes: an image pickup unit for capturing a subject; an image generation unit for performing image processing by different parameter values of a same parameter on an original image captured by the image pickup unit, and generating a plurality of images; and a multi-window display unit for displaying the plurality of images generated by the image generation unit or the original image and the plurality of images generated by the image generation unit. The parameter is white balance.

### BRIEF DESCRIPTION OF THE DRAWINGS

FIG. 1 is a block diagram of the digital camera as an image pickup apparatus according to an embodiment of the present invention;

FIG. 2 is a back view of the appearance of the digital camera;

FIG. 3 shows a display screen example of the first hierarchical level menu;

FIG. 4 shows a display screen example of the second hierarchical level menu;

FIG. 5 shows a screen example of the multi-window display according to the plus exposure correction;

FIG. 6 shows a screen example of the multi-window display according to the minus exposure correction;

FIG. 7 shows a screen example of full-screen display of the live view image of the amount of exposure correction of −1.3 EV;

FIG. 8 shows a display screen example of the second hierarchical level menu;

FIG. 9 shows a screen example of the multi-window display according to the outdoor white balance;

FIG. 10 shows a screen example of the multi-window display according to the indoor white balance;

FIG. 11 shows a screen example of full-screen display of the live view image obtained by performing a white balance correction appropriate for shooting an image in fine weather;

FIG. 12 is a flowchart of the process contents of a multi-window displaying operation;

FIG. 13 is a flowchart of the process contents of the OK key determination A; and

FIG. 14 is a flowchart of the process contents of the OK key determination B.

### DESCRIPTION OF THE PREFERRED EMBODIMENT

The embodiments of the present invention are described below with reference to the attached drawings.

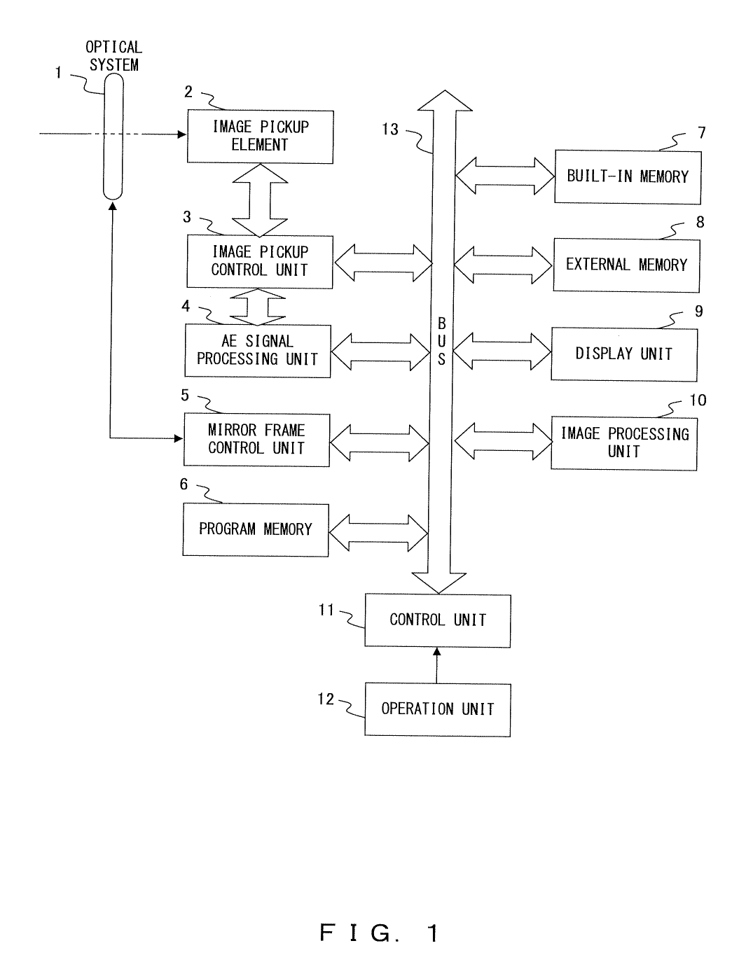

FIG. 1 is a block diagram of the digital camera as an image pickup apparatus according to an embodiment of the present invention.

In FIG. 1, an optical system 1 contains a lens for forming an image of a subject on an image pickup element 2, and a mirror frame not shown in the attached drawings but supporting the lens. A change of a focal distance and focusing can be performed by the mirror frame.

The image pickup element 2 is an image sensor configured by a plurality of pixels such as a CCD (charge coupled device), a CMOS (complementary metal oxide semiconductor), etc., photo-electrically converting an image-formed subject, and outputs an analog electrical signal.

An image pickup control unit 3 controls the operation of the image pickup element 2, performs analog signal processing such as a CDS (correlated double sampling), an AGC (automatic gain control), etc., then converts the signal into a digital electrical signal, further performs digital signal processing such as a pixel interpolating process, a color correcting process, etc., and outputs the result as image data of the original image. The image data is temporarily stored in external memory 8.

An AE (automatic exposure) signal processing unit 4 acquires brightness information about the subject image-formed on the image pickup element 2 from the analog electrical signal output from the image pickup element 2. Thus, the AE signal processing unit 4 can acquire the brightness distribution information about the subject field in the shooting angle of view. The AE signal processing unit 4 is also a brightness distribution measurement unit for measuring the brightness distribution in the shooting angle of view.

A mirror frame control unit 5 controls the mirror frame included in the optical system 1.

Program memory 6 is non-volatile memory such as flash memory etc. capable of realizing an electrically rewriting operation. The memory 6 stores a camera program executed by the CPU not shown in the attached drawings but provided for a control unit 11, and various data used during the execution of the camera program.

Built-in memory 7 is, for example, SDRAM (synchronous dynamic random access memory), and stores image data output from the image pickup control unit 3. It is also used as an image developed area when an image processing unit 10 performs a process.

The external memory 8 is a memory card attached/detached to and from the digital camera, for example, a xD Picture Card (registered trademark), a CompactFlash (registered trademark) card, etc., and records image data of a shot image, image data of an image edited by the editing function of the digital camera.

A display unit 9 displays a live view image, moving pictures, a still image, camera information, etc. A live view image is an image displayed as a subject image formed by the image pickup element 2 on the display unit 9 substantially in real time. The display unit 9 can also simultaneously display a plurality of live view images treated in different image processing. Thus, simultaneously displaying a plurality of images is referred to as multi-window display.

The image processing unit 10 performs image processing on the image data of the original image output from the image pickup control unit 3 using different parameter values of the same shooting parameter, thereby generating plural pieces of image data. The different parameter values of the same shooting parameter can be, for example, different exposure correction values of exposure correction, different white balance values of white balance, etc. In addition, the image processing unit 10 performs various image processing on image data such as a compression/decompression process on image data by, for example, the JPEG (joint photographic experts group) system etc when image data is recorded or recorded image data is displayed, an expanding/reducing process (resizing process) to increase/decrease the number of pixels configuring an image.

The control unit 11 integrally controls all blocks, and the CPU not shown in the attached drawings but internally provided in the unit reads a camera program stored in the program memory 6 and executes it, thereby controlling the entire operations of the digital camera.

An operation unit 12 includes various buttons, switches, etc. for accepting various instructions from a user and notifying the control unit 11 of the instructions. For example, it includes a release button, a zoom button, a mode setting dial, a key switch, etc. described later.

Each of the above-mentioned image pickup control unit 3, AE signal processing unit 4, mirror frame control unit 5, program memory 6, built-in memory 7, external memory 8, display unit 9, image processing unit 10, and control unit 11 is connected to a bus 13 to communicate data among them

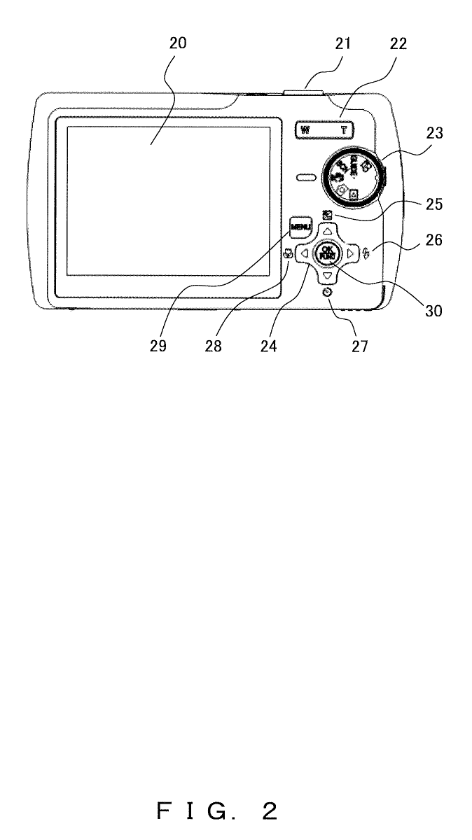

FIG. 2 is a back view of the appearance of the digital camera according to an embodiment of the present invention.

In FIG. 2, a TFT 20 is color liquid crystal included in the display unit 9 shown in FIG. 1, and displays an image, camera information, etc.

A release button 21 issues a shoot instruction. A zoom button 22 issues a zoom instruction for tele-zoom or wide-zoom.

A mode setting dial 23 is a rotary dial for selection of a mode to be used from among various modes such as a still image shooting mode, a reproduction mode, a camera shake suppressed shooting mode, and a moving picture shooting mode, etc.

A cross key 24 has a unitary construction of key switches (up key, down key, left key, and right key) as a cross key, and a key switch for setting exposure correction, flash, a self-shooting mode, and a macro shooting mode. The cross key 24 is a key switch for switching the movement of a cursor and the hierarchical level of a menu when a menu screen is displayed on the TFT 20.

An index 25 shows a setting position of exposure correction, and a user can perform exposure correction by pressing the triangle mark (up key) of the cross key 24 in the direction of the index.

An index 26 shows a setting position of flash, and a user can change a flash emission mode by pressing the triangle mark (right key) of the cross key 24 in the direction of the index.

An index 27 shows a setting position of a self-shooting mode, and a user can change to the self-shooting mode by pressing the triangle mark (down key) of the cross key 24 in the direction of the index.

An index 28 shows a setting position of a macro shooting mode, and a user can change to the macro shooting mode by pressing the triangle mark (left key) of the cross key 24 in the direction of the index.

A MENU key 29 is a key switch for issue of an instruction etc. for display of a menu screen on the TFT 20. An OK key 30 is a key switch for issue of an instruction to determine (confirm) a menu item when a menu screen is displayed on the TFT 20, an instruction to determine an image when a plurality of images are multi-window-displayed on the TFT 20, an instruction to change into a function setting mode.

Described next are operation examples of multi-window display for allowing a user to easily and appropriately select a parameter value of a shooting parameter such as exposure correction, white balance, etc. as operations of the digital camera according to the present embodiment.

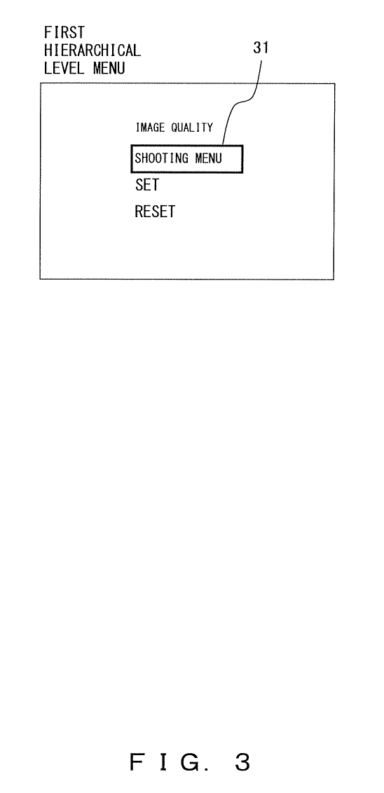

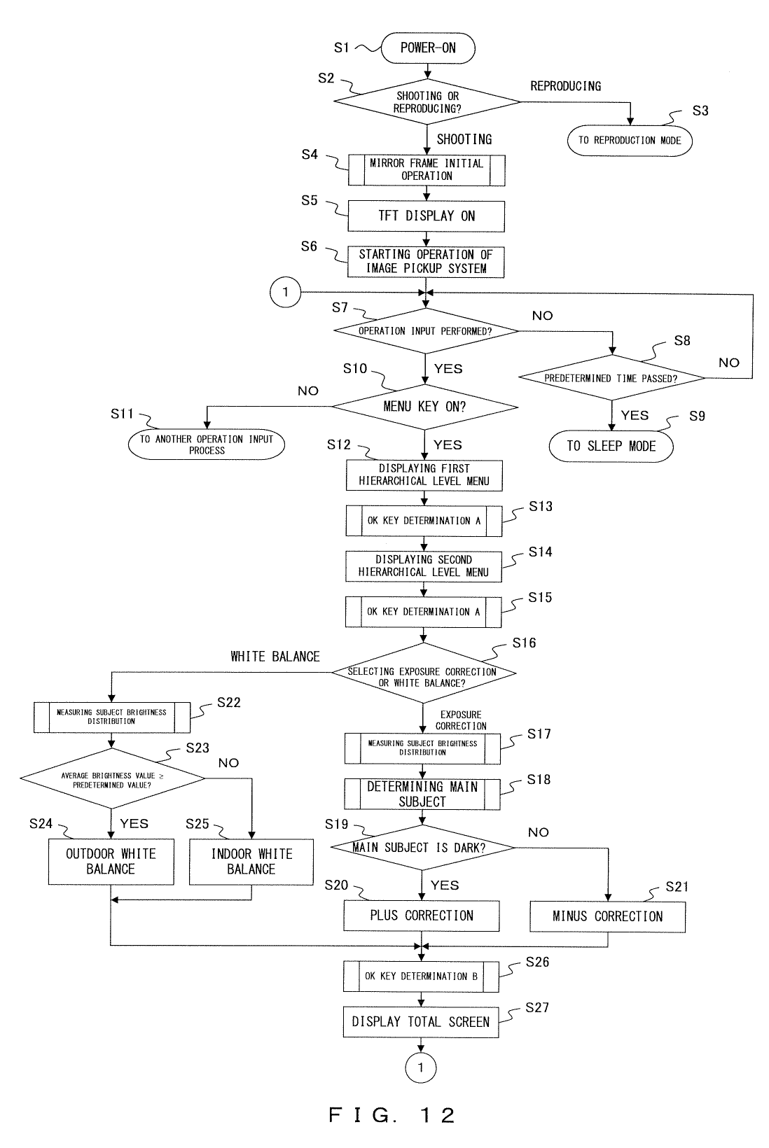

First, the outlines of the operations are described with reference to display screen example shown in FIGS. 3 through 11, and next, the details of the operations are described using flowcharts shown in FIGS. 12 through 14.

With the digital camera according to the present embodiment, if the MENU key 29 is pressed when power is turned on, the first hierarchical level menu in which operations relating to four items can be entered is displayed on the TFT 20 as in the display screen example shown in FIG. 3. The four items are an item “image quality” for setting the image quality of an image to be shot, an item “shooting menu” for setting the item of the shooting menu described later, an item “setting” for setting the digital camera such as selection of a display language, setting a built-in clock, etc., and an item “reset” for the initialization of a user-set shooting mode etc. In the first hierarchical level menu, by moving a cursor 31 up and down using the cross key 24, a desired item can be selected. In the example shown in FIG. 3, the “shooting menu” is selected.

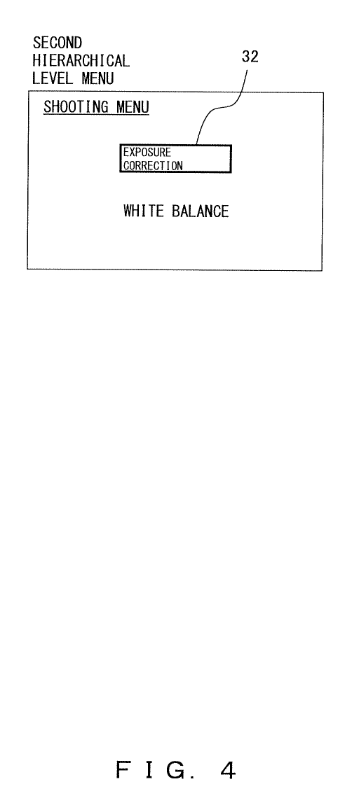

In the first hierarchical level menu, if the OK key 30 is pressed when the “shooting menu” is selected, the second hierarchical level menu relating to the shooting menu is displayed on the TFT 20 as in the display screen example shown in FIG. 4. In the second hierarchical level menu, the operations relating to two items can be entered. The two items are an item “exposure correction” for performing the multi-window display relating to the exposure correction, and an item “white balance” for multi-window-displaying relating to white balance. In the second hierarchical level menu, a desired item can be selected by the operation of the cross key 24 moving a cursor 32 up and down. In the example shown in FIG. 4, the “exposure correction” is selected.

In the second hierarchical level menu, if the OK key 30 is pressed when the “exposure correction” is selected, it is first determined whether the main subject is in a backlighted state or a lighted state.

The determination is performed based on the brightness distribution information about the subject field acquired by the AE signal processing unit 4. According to the brightness distribution information, if it is determined that there is an area partially indicating lower brightness than average brightness in the shooting range, and the area is a main subject, it is determined that the area is in the backlighted state. In other case, it is determined that the area is in the lighted state. The main subject can be, for example, a center area in the shooting range and an area focus is acquired by auto-focusing in the shooting range.

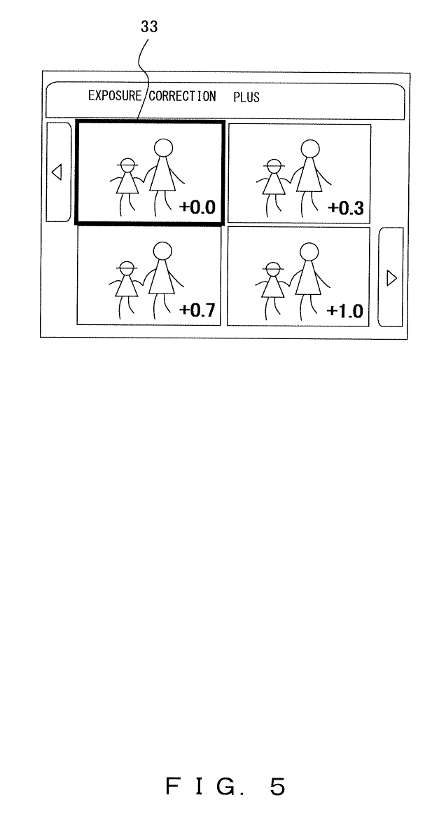

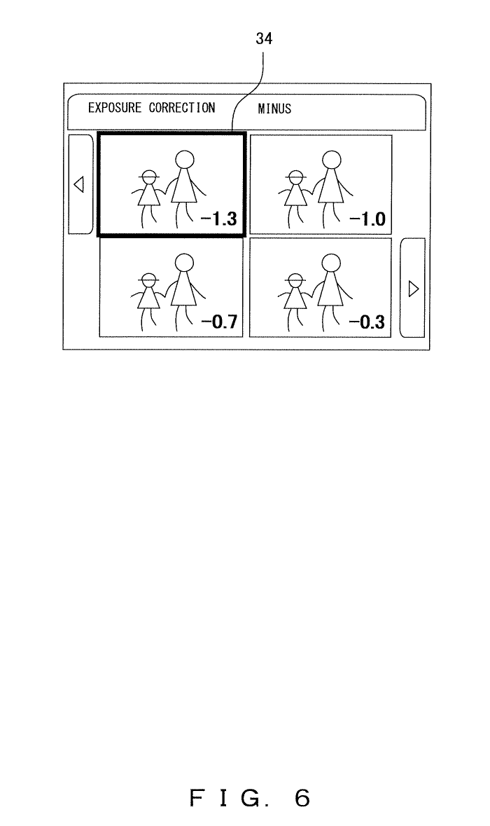

As a result of the determination, if it is determined that the subject is in the backlighted state, the multi-window display is performed relating to the plus exposure correction on the TFT 20 as in the display screen example shown in FIG. 5. In this multi-window display, a live view image as an original image and a plurality of live view images generated by performing image processing by different amounts of exposure correction (exposure correction values) as plus correction in the direction of the exposure correction on the live view image as the original image are multi-window-displayed. At this time, the live view images are arranged depending on the value of the amount of exposure correction. In the display screen example shown in FIG. 5, the live view image of the original image of the amount of exposure correction of 0.0 EV is arranged at the upper left position, the live view image of the original image of the amount of exposure correction of +0.3 EV is arranged at the upper right position, the live view image of the original image of the amount of exposure correction of +0.7 EV is arranged at the lower left position, and the live view image of the original image of the amount of exposure correction of +1.0 EV is arranged at the lower right position. In the display screen example shown in FIG. 5, for convenience in the drawings, four live view images are the same, but actually four live view images having different exposure depending on the amount of exposure correction are displayed (as in the display screen example shown in FIG. 6 described later). In the display screen example shown in FIG. 5, each live view image is displayed with its amount of exposure correction. The amount of exposure correction can be different in 0.3 EV or 0.5 EV unit. In this multi-window display, a desired live view image can be selected on the screen by the operation of the cross key 24 moving a cursor 33 up and down and from side to side. In addition, by continuously pressing the right key of the cross key 24, a plurality of live view images generated by performing image processing by different amounts of exposure correction as plus correction can be multi-window-displayed. Furthermore, by continuously pressing the left key of the cross key 24, the multi-window display relating to minus exposure correction can be performed as in the display screen example shown in FIG. 6 described later.

On the other hand, as a result of a determination as to whether the main subject is in the backlighted state or lighted state, if it is determined that the subject is in the lighted state, the multi-window display is performed relating to the minus exposure correction on the TFT 20 as in the display screen example shown in FIG. 6. In this multi-window display, a live view image as an original image and a plurality of live view images generated by performing image processing by different amounts of exposure correction (exposure correction values) as minus correction in the direction of the exposure correction on the live view image as the original image are multi-window-displayed. At this time, the live view images are arranged depending on the value of the amount of exposure correction. In the display screen example shown in FIG. 6, the live view image of the original image of the amount of exposure correction of −1.3 EV is arranged at the upper left position, the live view image of the original image of the amount of exposure correction of −0.0 EV is arranged at the upper right position, the live view image of the original image of the amount of exposure correction of −0.7 EV is arranged at the lower left position, and the live view image of the original image of the amount of exposure correction of −0.3 EV is arranged at the lower right position. In the display screen example shown in FIG. 6, each live view image is displayed with its amount of exposure correction. The amount of exposure correction can be different in 0.3 EV or 0.5 EV unit. In this multi-window display, a desired live view image can be selected on the screen by the operation of the cross key 24 moving a cursor 34 up and down and side to side. In addition, by continuously pressing the left key of the cross key 24, a plurality of live view images generated by performing image processing by different amounts of exposure correction as minus correction can be multi-window-displayed. Furthermore, by continuously pressing the right key of the cross key 24, the multi-window display relating to plus exposure correction can be performed as in the display screen example shown in FIG. 5 described above.

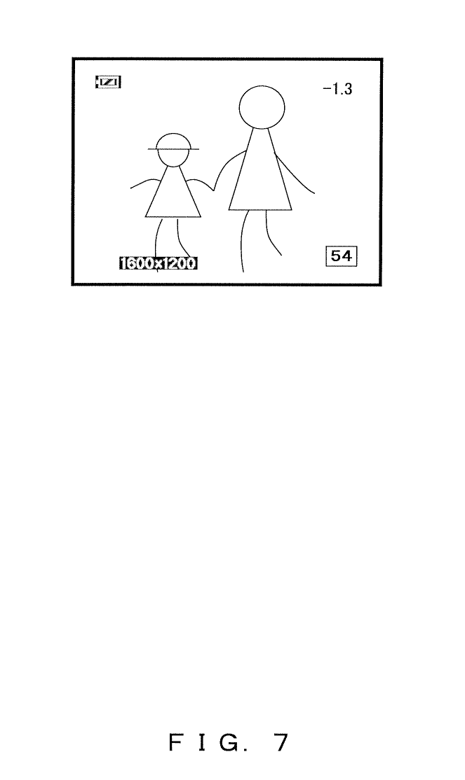

For example, in the multi-window display relating to the minus exposure correction shown in FIG. 6, if the OK key 30 is pressed when the live view image at the upper left position is selected, the live view image is display on the entire screen as in the display screen example shown in FIG. 7, thereby entering a wait-for-shooting state. At this time, −1.3 EV is automatically set as an amount of exposure correction. On the display screen shown in FIG. 7, the set amount of exposure correction, the icon indicating the remaining amount of the battery, the image shooting size, and the number of images to be shot are also displayed together.

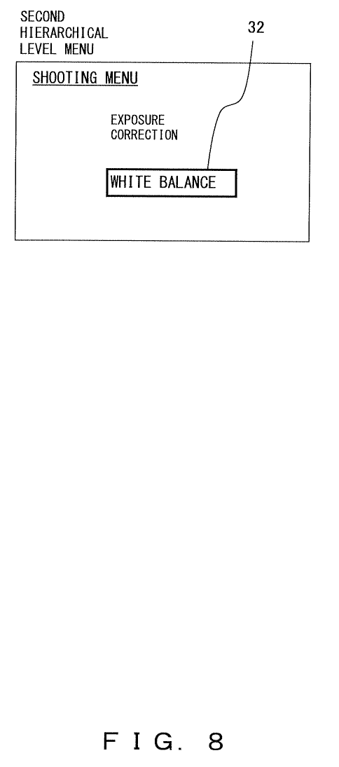

In the second hierarchical level menu shown in FIG. 4, when the cursor 32 is moved down by the operation of the cross key 24, the “white balance” is selected as in the display screen example shown in FIG. 8.

Thus, if the OK key 30 is pressed when the “white balance” is selected, it is first determined whether the shooting place is outdoor or indoor.

The determination is performed based on the brightness distribution information about the subject field acquired by the AE signal processing unit 4 according to the analog electrical signal output from the image pickup element 2. According to the brightness distribution information, the average brightness value in the shooting range is equal to or exceeds a predetermined value, that is, if it is bright, it indicates outdoor. On the other hand, if the average brightness value in the shooting range is lower than a predetermined value, that is, if it is dark, it indicates indoor. The determination can be performed by detecting the presence/absence of artificial light, or by measuring the color temperature of a subject.

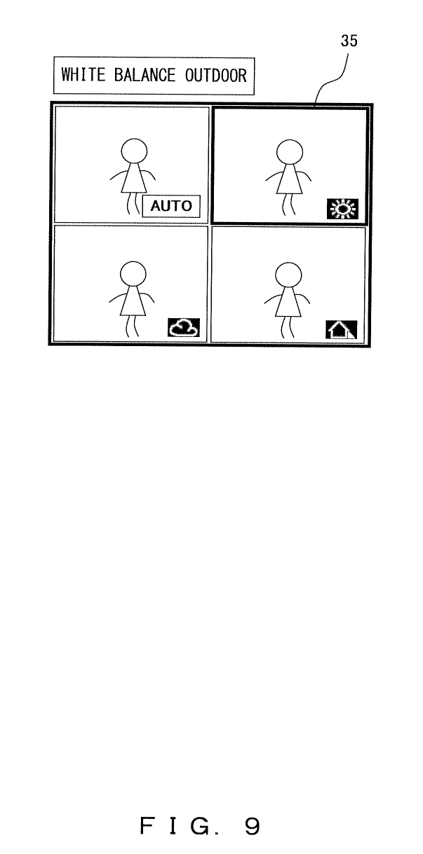

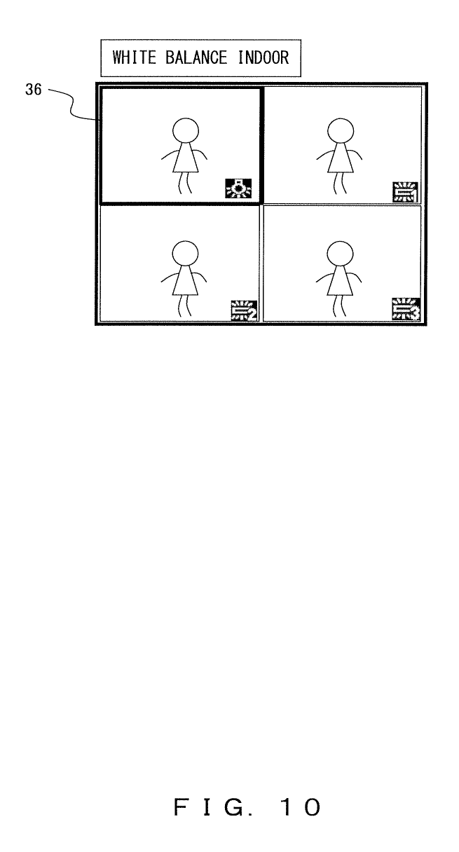

As a result of the determination, if it is determined that the shooting place is outdoor, then the multi-window display relating to the white balance for outdoor is performed on the TFT 20 as in the display screen example shown in FIG. 9. In this multi-window display, a live view image generated by performing image processing by a white balance value automatically determined by the digital camera on a live view image as an original image, and a plurality of live view images generated by performing image processing by different white balance values (different white balance values with outdoor shooting taken into account) appropriate for outdoor shooting are multi-window-displayed. At this time, the live view images are arranged depending on the values of the white balance values. In the display screen example shown in FIG. 9, a live view image obtained by applying the white balance value automatically determined by the digital camera to a live view image of an original image, that is, a live view image obtained by automatically performing the white balance correction on the live view image of an original image, is arranged at the upper left position of the screen. A live view image obtained by applying a white balance value appropriate for shooting in fine weather to a live view image of an original image, that is, a live view image obtained by performing white balance correction appropriate for shooting in fine weather, is arranged at the upper right position on the screen. A live view image obtained by applying a white balance value appropriate for shooting in cloudy weather to a live view image of an original image, that is, a live view image obtained by performing white balance correction appropriate for shooting in cloudy weather, is arranged at the lower left position on the screen. A live view image obtained by applying a white balance value appropriate for shooting in the shade to a live view image of an original image, that is, a live view image obtained by performing white balance correction appropriate for shooting in the shade, is arranged at the lower right position on the screen. In the display screen example shown in FIG. 9, for convenience in the drawings, four live view images are the same, but actually four live view images of different white balance depending on the respective white balance values are displayed (as in the display screen example shown in FIG. 10). In the display screen example shown in FIG. 9, the icon corresponding to the white balance value is displayed together for each live view image. However, the characteristics “AUTO” are displayed for the live view image on which the white balance correction is automatically performed. In this multi-window display, by the operation of the cross key 24 moving a cursor 35 up and down and from side to side, a desired live view image on the screen can be selected. In addition, by continuously pressing the right key of the cross key 24, a plurality of live view images generated by performing image processing by another white balance value appropriate for outdoor shooting can be multi-window-displayed. Furthermore, by continuously pressing the left key of the cross key 24, the multi-window display relating to the indoor white balance correction can also be performed as in the display screen example shown in FIG. 10 described later.

On the other hand, as a result of the determination as to whether the shooting place is outdoor or indoor, if it is determined that the shooting place is indoor, then the multi-window display relating to the white balance for indoor is performed on the TFT 20 as in the display screen example shown in FIG. 10. In this multi-window display, a plurality of live view images generated by performing image processing by different white balance values (different white balance values with indoor shooting taken into account) appropriate for indoor shooting are multi-window-displayed. At this time, the live view images are arranged depending on the values of the white balance values. In the display screen example shown in FIG. 10, a live view image obtained by applying a white balance value appropriate for shooting under an electric lamp to a live view image of an original image, that is, a live view image obtained by performing white balance correction appropriate for shooting under an electric lamp, is arranged at the upper left position on the screen. A live view image obtained by applying a white balance value appropriate for shooting under a fluorescent lamp of daylight-balanced color to a live view image of an original image, that is, a live view image obtained by performing white balance correction appropriate for shooting under a fluorescent lamp of daylight-balanced color, is arranged at the upper right position on the screen. A live view image obtained by applying a white balance value appropriate for shooting under a fluorescent lamp of white daylight color to a live view image of an original image, that is, a live view image obtained by performing white balance correction appropriate for shooting under a fluorescent lamp of white daylight color, is arranged at the lower left position on the screen. A live view image obtained by applying a white balance value appropriate for shooting under a white fluorescent lamp to a live view image of an original image, that is, a live view image obtained by performing white balance correction appropriate for shooting under a white fluorescent lamp, is arranged at the lower right position on the screen. In the display screen example shown in FIG. 10, the icon corresponding to the white balance value is displayed together for each live view image. In this multi-window display, by the operation of the cross key 24 moving a cursor 36 up and down and from side to side, a desired live view image on the screen can be selected. In addition, by continuously pressing the right key of the cross key 24, a plurality of live view images generated by performing image processing by another white balance value appropriate for indoor shooting can be multi-window-displayed. Furthermore, by continuously pressing the right key of the cross key 24, the multi-window display relating to the outdoor white balance correction can also be performed as in the display screen example shown in FIG. 9 described above.

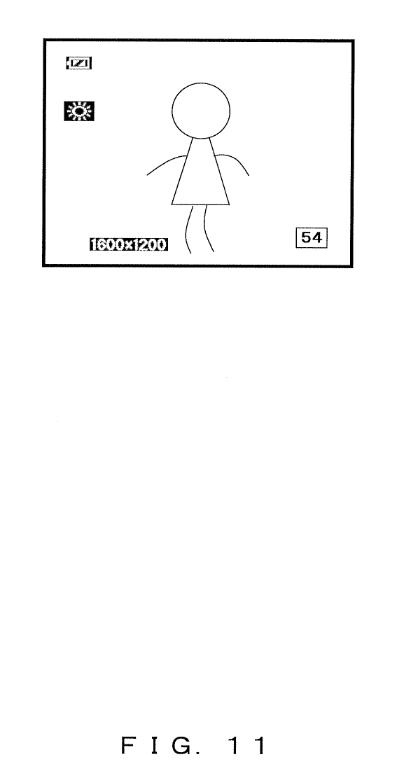

For example, in the multi-window display relating to the outdoor white balance shown in FIG. 9, if the OK key 30 is pressed when the live view image at the upper right position is selected, the live view image is display on the entire screen as in the display screen example shown in FIG. 11, thereby entering a wait-for-shooting state. At this time, a white balance value appropriate for the shooting in fine weather is automatically set as a white balance value. On the display screen shown in FIG. 11, the icon corresponding to the set white balance value, the icon indicating the remaining amount of the battery, the image shooting size, and the number of images to be shot are also displayed together.

The operations of the multi-window display described above with reference to FIGS. 3 through 11 are described below in detail with reference to the flowcharts shown in FIGS. 12 through 14.

As shown in FIG. 12, first in step (hereinafter referred to simply as “S”) 1, when the digital camera is turned on, the CPU of the control unit 11 starts executing the camera program stored in the program memory 6, and the control unit 11 starts its operation.

In S2, it is determined whether the mode setting dial 23 is set in the shooting mode or the reproduction mode. If the dial is set in the reproduction mode, control is passed to S3. If it is set in the shooting mode, control is passed to S4.

In S3, control is passed to the process routine of the reproduction mode not shown in the attached drawings.

In S4, after the mirror frame included in the optical system 1 is driven to a predetermined initial position, a lens for adjusting the focus is driven to the initial position, thereby performing the initial mirror frame operation.

In S5, the display of the TFT 20 included in the display unit 9 is turned on.

In S6, the image pickup system including the image pickup element 2, the image pickup control unit 3, and the AE signal processing unit 4 starts its operation. Thus, the display of the live view image (entire screen display) is started.

In S7, it is determined whether or not an operation input (operation by the operation unit 12) has been performed. If the operation input is performed (YES in S7), control is passed to S10. If it is not performed (NO in S7), control is passed to S8.

In S8, it is determined whether or not a predetermined time has passed in a no operation input state. If there is no operation input after a predetermined time has passed (YES in S8), control is passed to S 9. If a predetermined time has not passed yet (NO in S8), control is returned to S7, thereby making determination in S7 again.

In S9, control enters a sleep mode (energy saving mode) not shown in the attached drawings.

On the other hand, in S10, it is determined whether or not the operation input is the MENU key 29. If it is not the MENU key 29 (NO in S10), control is passed to S11. If it is the MENU key 29 (YES in S10), control is passed to S12.

In S11, control is passed to another operation input process not shown in the attached drawings. For example, if the operation input is the release button 21, a shooting operation is performed based on the set shooting parameter etc. in the other operation input process.

In S12, the first hierarchical level menu shown in FIG. 3 is displayed on the TFT 20. The initial state of the cursor position is the position of the “shooting menu”.

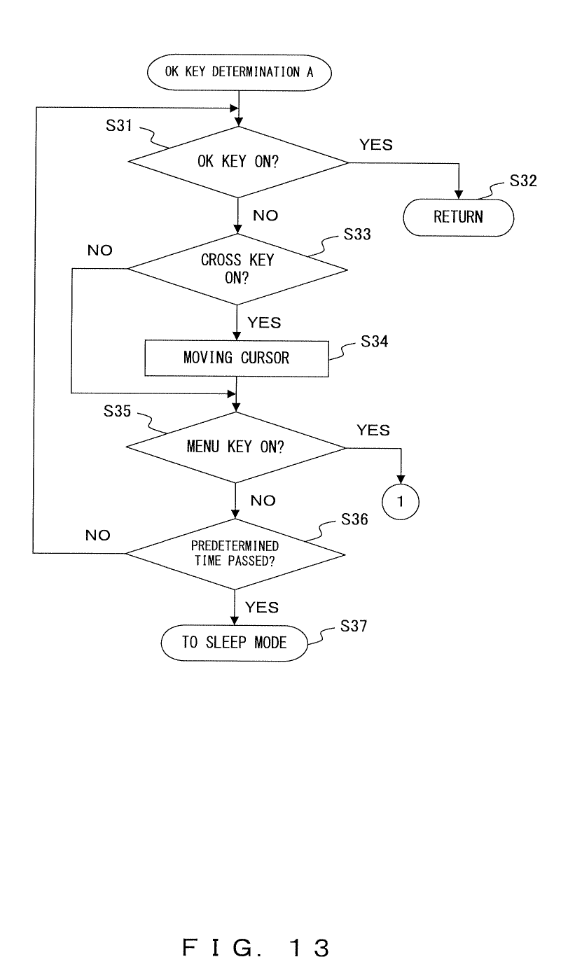

In S13, the subroutine of “OK key determination A” shown in FIG. 13 and described later for determination as to whether or not the OK key 30 has been pressed is called. In this subroutine, when it is determined that the OK key 30 has been pressed in the state in which the “shootingmenu” of the first hierarchical level menu is selected, control is passed to S14.

In S14, the second hierarchical level menu shown in FIG. 4 is displayed on the TFT 20. The initial state of the cursor position is the position of the “exposure correction”.

In S15, the subroutine of “OK key determination A” shown in FIG. 13 and described later for determination as to whether or not the OK key 30 has been pressed is called. In this subroutine, when the OK key 30 is pressed, control is passed to S16.

In S16, it is determined whether the “exposure correction” or the “white balance” of the second hierarchical level menu has been selected when the OK key 30 is pressed. If the “exposure correction” has been selected, control is passed to S17. If the “white balance” has been selected, control is passed to S22.

In S17, the brightness distribution information about the subject field acquired by the AE signal processing unit 4 from the analog electrical signal output from the image pickup element 2 is obtained, and simultaneously an average brightness value is calculated, thereby performing the subject brightness distribution measuring process.

In S18, performed is the main subject determining process of determining in which area in the image (live view image) the main subject is located. In this example, the area that is put into focus by an autofocus system is processed as a main subject.

In S19, it is determined whether or not the brightness of the area of the main subject determined in S18 is equal to or lower than a predetermined level (darker) with respect to the average brightness. If it is equal to or lower than the predetermined level (darker) with respect to the average brightness (YES in S19), control is passed to S20. If not (NO in S19), control is passed to S21. The determination in S19 can be made by, for example, passing control to S20 when the average brightness value in the area of the main subject determined in S18 is equal to or lower than a predetermined value (darker) with respect to the average brightness value calculated in S17, then control is passed to S20. Otherwise, control is passed to S21.

In S20, it is determined that the main subject is in the backlighted state, and settings are made to perform the multi-window display relating to the plus exposure correction as the multi-window display first performed in the subroutine of the “OK key determination B” called in S26 described later, thereby passing control to S26.

In S21, it is determined that the main subject is in the lighted state, and settings are made to perform the multi-window display relating to the minus exposure correction as the multi-window display first performed in the subroutine of the “OK key determination B” called in S26 described later, thereby passing control to S26.

On the other hand, in S22, as in S17 above, the brightness distribution information about the subject field acquired by the AE signal processing unit 4 from the analog electrical signal output from the image pickup element 2 is obtained, and simultaneously an average brightness value is calculated, thereby performing the subject brightness distribution measuring process.

In S23, it is determined whether or not the average brightness value calculated in S22 is equal to or exceeds a predetermined value. If it is equal to or exceeds a predetermined value (YES in S23), control is passed to S24. Otherwise (NO in S23), control is passed to S25.

In S24, it is determined that the shooting place is outdoor, and settings are made to perform the multi-window display relating to the outdoor white balance as the multi-window display first performed in the subroutine of the “OK key determination B” called in S26 described later, thereby passing control to S26.

In S25, it is determined that the shooting place is indoor, and settings are made to perform the multi-window display relating to the indoor white balance as the multi-window display first performed in the subroutine of the “OK key determination B” called in S26 described later, thereby passing control to S26.

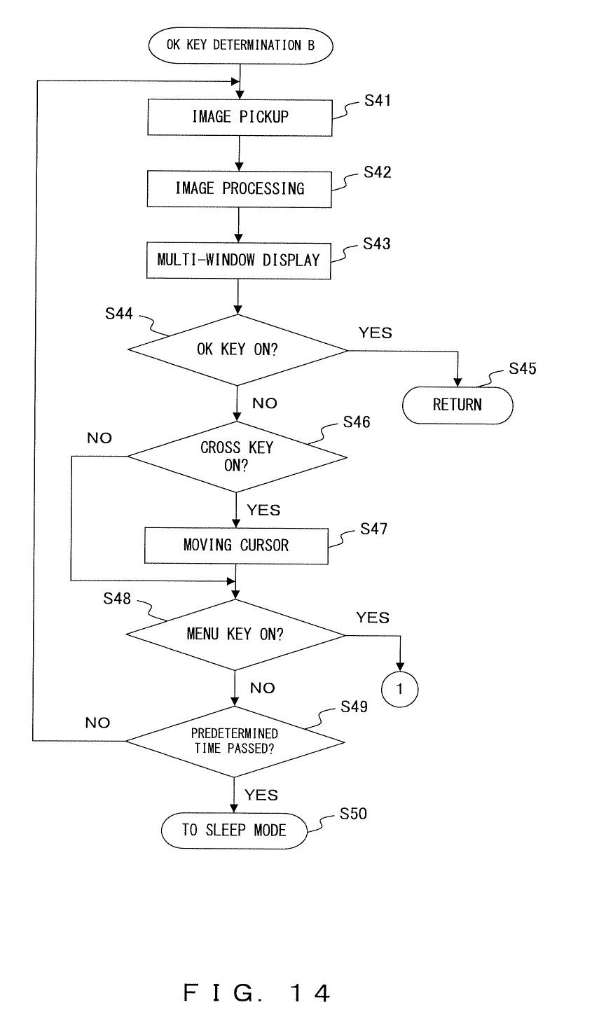

In S26, the subroutine of “OK key determination B” shown in FIG. 14 and described later for determination as to whether or not the OK key 30 has been pressed is called. In this subroutine, when the OK key 30 is pressed, control is passed to S27.

In S27, the live view image selected in the multi-window display of the TFT 20 when the OK key 30 is pressed is displayed on the entire screen, and the parameter value of the live view image is set on the digital camera. For example, if the multi-window display is shown in FIG. 6, the entire screen shown in FIG. 7 is displayed and −1.3 EV is set as the amount of exposure correction on the digital camera. Otherwise, if the multi-window display is shown in FIG. 9, the entire screen shown in FIG. 11 is displayed and the white balance value appropriate for the shooting in fine weather is set as a white balance value on the digital camera.

When the process in S27 is completed, control is returned to S7, and the wait-for-shooting state is entered. If the release button 21 is pressed, the shooting operation is performed based on the parameter value set in S27.

Next, the process contents of the subroutine of the “OK key determination A” called in S13 and S15 are described below with reference to the flowchart shown in FIG. 13.

As shown in FIG. 13, first in S31, it is determined whether or not the OK key 30 has been pressed. If the OK key 30 has been pressed (YES in S31), control is passed to S32. Otherwise (NO in S31), control is passed to S33.

In S32, control is returned to the process.

In S33, it is determined whether or not the cross key 24 has been pressed. If the cross key 24 has been pressed (YES in S33), control is passed to S34. Otherwise (NO in S33), S34 is skipped and control is passed to S35.

In S34, the cursor (31 or 32) on the menu displayed on the TFT 20 is moved up and down depending on the direction of the cross key 24 (for example, the up key or the down key).

In S35, it is determined whether or not the MENU key 29 has been pressed. If the MENU key 29 has been pressed (YES in S35), control is passed to S7 shown in FIG. 12. Otherwise (NO in S35), control is passed to S36. If control is passed to S7, The wait-for-shooting state is entered.

In S36, it is determined whether or not a predetermined time has passed in a no operation input state. If there is no operation input after a predetermined time has passed (YES in S36), then control is passed to S37. If a predetermined time has not passed yet (NO in S36), control is returned to S31, and the determination in S31 is performed.

In S37, control is passed to the sleep mode (energy saving mode) not shown in the attached drawings.

Next, the process contents of the subroutine of the “OK key determination B” called in S26 above is described below using the flowchart shown in FIG. 14.

As shown in FIG. 14, first in S41, an image is captured, and image data relating to the original image for performing the image processing is obtained.

In S42, image processing is performed on the image data relating to the original image acquired in S41 using different parameter values of the same parameter (exposure correction of white balance), thereby generating plural pieces of image data. For details, if the process performed before the subroutine call of the “OK key determination B” is performed is the process in S20 or S21, then plural pieces of image data are generated by performing the image processing by different amounts of exposure correction (exposure correction value). Otherwise, if the process performed before the subroutine call of the “OK key determination B” is performed is the process in S24 or S25, then plural pieces of image data are generated by performing the image processing by different white balance values.

In S43, an original image relating to the image data acquired in S41 and a plurality of images relating to the plural pieces of image data generated in S42, or a plurality of images relating to the plural pieces of image data generated in S42 are multi-window-displayed on the TFT 20. For example, if the process in S43 is first performed in the subroutine of the “OK key determination B”, and the process performed before the subroutine of the “OK key determination B” is called is the process in S20, the multi-window display relating to the plus exposure correction as shown in FIG. 5 is performed. Otherwise, if the process in S43 is first performed in the subroutine of the “OK key determination B”, and the process performed before the subroutine of the “OK key determination B” is called is the process in S21, the multi-window display relating to the minus exposure correction as shown in FIG. 6 is performed. Otherwise, if the process in S43 is first performed in the subroutine of the “OK key determination B”, and the process performed before the subroutine of the “OK key determination B” is called is the process in S24, the multi-window display relating to the outdoor white balance as shown in FIG. 9 is performed. Otherwise, if the process in S43 is first performed in the subroutine of the “OK key determination B”, and the process performed before the subroutine of the “OK key determination B” is called is the process in S25, the multi-window display relating to the indoor white balance as shown in FIG. 10 is performed. If the process in 43 is first performed in the subroutine of the “OK key determination B”, the cursor (35 or 36) is displayed on the image at the upper left of the screen.

In S44, it is determined whether or not the OK key 30 has been pressed. If it is determined that the OK key 30 has been pressed (YES in S44), control is passed to S 45. Otherwise (NO in S44), control is passed to S46.

In S45, control is returned to the process.

In S46, it is determined whether or not the cross key 24 has been pressed. If the cross key 24 has been pressed (YES in S46), control is passed to S47. Otherwise (NO in S46), S47 is skipped, and control is passed to S48.

In S47, the cursor on the multi-window display is moved up and down from side to side depending on the direction of the press of the cross key 24 (up key, down key, left key, and right key). However, if the left key is pressed while the cursor is displayed on the image at the upper left of the screen, or if the right key is pressed while the cursor is displayed on the image at the lower right of the screen, then a plurality of image relating to plural pieces of image data generated by performing image processing by other different parameter values generated in S42, or an original image relating to the image data acquired in S41 and a plurality of images relating to the plural pieces of image data generated by performing the image processing by other different parameter values generated in S42 are newly multi-window-displayed. Thus, for example, the multi-window display shown in FIG. 5 can be switch to the multi-window display shown in FIG. 6, or the inverse switch etc. can be performed. In addition, switching from the multi-window display shown in FIG. 9 to the multi-window display shown in FIG. 10 or the inverse switch etc. can be performed.

In S48, it is determined whether or not the MENU key 29 has been pressed. If the MENU key 29 has been pressed (YES in S48), control is passed to S7 shown in FIG. 12. Otherwise (NO in S48), control is passed to S49. If control is passed to S7, The wait-for-shooting state is entered.

In S49, it is determined whether or not a predetermined time has passed in a no operation input state. If there is no operation input after a predetermined time has passed (YES in S49), then control is passed to S50. If a predetermined time has not passed yet (NO in S49), control is returned to S41, and the process in S41 is performed. Thus, when there is no operation input, a series of processes, that is, the “image pickup” in S41, the “image processing” in S42, and the multi-window display n S43, are repeatedly performed, and a plurality of live view images having different parameters are multi-window-displayed on the TFT 20.

In S50, a sleep mode (energy-saving mode) not shown in the attribute is entered.

As described above, according to the digital camera of the present embodiment, a plurality of images of different parameter values of the same shooting parameters (exposure correction or white balance) can be multi-window-displayed. Therefore, even a beginner of a camera can easily understand the difference in parameter value.

In addition, since a series of processes such as capturing an original image, image processing (image generation), multi-window display, etc. are repeatedly performed, even if there are changes in movement and the brightness of a subject, the current state of the subject can be correctly reflected on the multi-window display. Therefore, a camera operator can set a parameter value of the shooting parameter independent of the memory of the past.

Furthermore, when the multi-window display over a plurality of pages can be performed, the optimum page is automatically displayed first. Therefore, it is very convenient in operation. For example, when the multi-window display over two pages as shown in FIGS. 9 and 10 can be performed, and the shooting place is outdoor, the multi-window display (FIG. 9) relating to the outdoor white balance appropriate for outdoor use is automatically performed. Therefore, it is very convenient in operation.

With the digital camera according to the present embodiment, when multi-window display is performed, the maximum of four live view images can be displayed on one screen. However, any number of live view images can also be displayed.

With the digital camera according to the present invention, the shooting parameter that can be multi-window-displayed is exposure correction or white balance, but other shooting parameters such as a shooting scene etc. can be used. When the shooting parameter is a shooting scene, a parameter value appropriate for the shooting scene such as a portrait, landscape, nightscape, sports, etc. can be applied.

In addition, the image pickup apparatus according to the present embodiment can also be configured as, in addition to the digital camera described above, a mobile telephone with camera, a PHS (personal handy-phone system) with camera, a PDA (personal digital assistant) with camera, etc.

The present invention has been described above in detail, but the present invention is not limited to the above-mentioned embodiments, but can be modified or improved within the gist of the present invention.

As described above, the present invention allows a user to easily understand the shooting parameter changing function, and easily and appropriately select the parameter value.

What is claimed is:

1. An image pickup apparatus, comprising:
an image pickup unit capturing a subject;
an image generation unit performing image processing by different parameter values of a same parameter on an original image captured by the image pickup unit, and generating a plurality of images; and
a multi-window display unit displaying the plurality of images generated by the image generation unit or the original image and the plurality of images generated by the image generation unit, wherein
the parameter is exposure correction.

2. The apparatus according to claim 1, further comprising
a brightness distribution measurement unit measuring the brightness distribution in the shooting angle of view, wherein
depending on the brightness distribution measured by the brightness distribution measurement unit, a plurality of image generated by performing image processing by a parameter value as plus correction in a direction of exposure correction, or a plurality of images generated by performing image processing by a parameter value as minus exposure in a direction of exposure correction are multi-window-displayed.

3. The apparatus according to claim 2, wherein
when a backlighted state is determined from a brightness distribution measured by the brightness distribution measurement unit, a plurality of images generated by performing image processing by a parameter value as plus correction in a direction of exposure correction are multi-window-displayed.

4. The apparatus according to claim 2, wherein
when a lighted state is determined from a brightness distribution measured by the brightness distribution measurement unit, a plurality of images generated by performing image processing by a parameter value as minus correction in a direction of exposure correction are multi-window-displayed.

5. The apparatus according to claim 1, wherein
the multi-window display unit displays the plurality of images by superposing the parameter value and/or an icon indicating the parameter value on the plurality of images.

6. An image pickup apparatus, comprising:
an image pickup unit capturing a subject;
an image generation unit performing image processing by different parameter values of a same parameter on an original image captured by the image pickup unit, and generating a plurality of images; and
a multi-window display unit displaying the plurality of images generated by the image generation unit or the original image and the plurality of images generated by the image generation unit, wherein
the parameter is white balance.

7. The apparatus according to claim 6, further comprising
an outdoor/indoor determination unit determining whether a shooting place is outdoor or indoor, wherein
when the outdoor/indoor determination unit determines that the shooting place is outdoor, a plurality of images generated by performing image processing by a parameter value of white balance with outdoor shooting taken into account are multi-window-displayed, and when the outdoor/indoor determination unit determines that the shooting place is indoor, a plurality of images generated by performing image processing by a parameter value of white balance with indoor shooting taken into account are multi-window-displayed.

8. The apparatus according to claim 7, wherein
the outdoor/indoor determination unit determines whether the shooting place is outdoor or indoor according to brightness information about a subject field.

9. The apparatus according to claim 6, wherein
the multi-window display unit displays the plurality of images by superposing the parameter value and/or an icon indicating the parameter value on the plurality of images.

10. A processing method for an image pickup apparatus, comprising:
capturing a subject;
generating a plurality of images by performing image processing by different parameter value of exposure correction or white balance on captured original image; and
multi-window-displaying the plurality of images or the original image and the plurality of images.

11. The method according to claim 10, further comprising
measuring a brightness distribution in a shooting angle of view; and
depending on the measured brightness distribution, image processing by a different parameter value as plus correction in a direction of exposure correction, or image processing by a different parameter value as minus exposure in a direction of exposure correction are performed on the original image and the plurality of images are generated.

12. The method according to claim 11, wherein
when a backlighted state is determined from the measured brightness distribution, image processing by a different parameter value as plus correction in a direction of exposure correction is performed on the original image, and the plurality of images are generated.

13. The method according to claim 11, wherein
when a lighted state is determined from the measured brightness distribution, image processing by a different parameter value as minus correction in a direction of exposure correction is performed on the original image, and the plurality of images are generated.

14. The method according to claim 10, further comprising
determining whether a shooting place is outdoor or indoor according to brightness information about a subject field;
when it is determined that the shooting place is outdoor, performing image processing by a different parameter value with outdoor shooting taken into account on the original image, and generating the plurality of images; and
when it is determined that the shooting place is indoor, performing image processing by a different parameter value with indoor shooting taken into account on the original image, and generating the plurality of images.

15. The method according to claim 10, wherein
the parameter value and/or an icon indicating the parameter value are superposed on the plurality of images and multi-window-displayed.
